(19) United States
(12) Patent Application Publication
(10) Pub. No.: US 2018/0287388 A1
(43) Pub. Date: Oct. 4, 2018

(54) Controlled Distribution of Integrated Power Supplies for Electrical Loads

(71) Applicant: Rheem Manufacturing Company, Atlanta, GA (US)

(72) Inventor: Scott David Bates, Atlanta, GA (US)

(21) Appl. No.: 15/474,333

(22) Filed: Mar. 30, 2017

(51) Int. Cl. H02J 3/38; H02J 13/00; H02M 7/44

(52) U.S. Cl. CPC H02J 3/382; H02J 13/00; H02M 7/44; H02J 3/386; H02J 3/387; H02J 3/383

(57) ABSTRACT

A system can include an electrical load that consumes primary power and reserve power. The system can also include an alternative generation source coupled to the electrical load, wherein the alternative generation source provides the primary power. The system can further include at least one energy storage device coupled to the alternative generation source and the electrical load, where the at least one energy storage device provides the reserve power. The system can also include an external power demand coupled to the alternative generation source and the at least one energy storage device. The system can further include a controller coupled to the alternative generation source and the at least one energy storage device, where the controller controls a distribution of the primary power and the reserve power to the electrical load and the external power demand.

### TECHNICAL FIELD

The present disclosure relates generally to integrated power supplies for electrical loads, and more particularly to systems, methods, and devices for photovoltaic (PV) solar and other forms of alternative generation integrated with other power supplies to provide power to electrical loads that include water heating.

### BACKGROUND

PV solar generation is used to provide exclusive or supplemental power for electrical loads. These electrical loads can vary in their power requirements based on a number of factors, including but not limited to time of day, day of week, month of year, occupancy, and temperature. The amount of power generated by PV solar generation also varies based on one or more of a number of factors, including but not limited to time of day, month of year, position of the panels, number of panels, size of the panels, amount of dust and other debris on the panels, and cloud cover. In some cases, the power generated by PV solar generation can be stored for some period of time before it is used.

### SUMMARY

In general, in one aspect, the disclosure relates to a system. The system can include an electrical load that consumes primary power and reserve power, and an alternative generation source coupled to the electrical load, where the alternative generation source provides the primary power. The system can also include at least one energy storage device coupled to the alternative generation source and the electrical load, where the at least one energy storage device provides the reserve power. The system can further include a controller coupled to the alternative generation source and the at least one energy storage device, where the controller controls a distribution of the primary power and the reserve power to the electrical load and is configured to provide the primary power and the reserve power to an external power demand. The controller can provide the primary power and the reserve power to the external power demand based, in part, on at least one forecast parameter, where the at least one forecast parameter is based on historical data.

In another aspect, the disclosure can generally relate to a controller. The controller can include a control engine that controls a distribution of primary power and reserve power to an electrical load and an external power demand, where the primary power is provided by an alternative generation source, where the reserve power is provided by at least one energy storage device, where the electrical load and the external power demand each consume at least one selected from a group consisting of the primary power and the reserve power, where the external power demand receives the primary power and the reserve power based, in part, on at least one forecast parameter determined by the control engine, where the at least one forecast parameter is based on historical data.

In yet another aspect, the disclosure can generally relate to a non-transitory computer-readable medium that includes instructions that when executed by a hardware processor perform a method for distributing power in a system from multiple power sources. The method can include forecasting a demand of an electrical load for a future period of time, and forecasting a market price for electricity for the future period of time. The method can also include forecasting an amount of reserve power stored in at least one energy storage device for the future period of time, and forecasting an amount of primary power generated by an alternative generation source for the future period of time. The method can further include configuring, at a start of the future period of time, at least one switch based on the demand, the market price, the amount of reserve power stored in the at least one energy storage device, and the amount of primary power generated by the alternative generation source. Configuring the at least one switch can distribute the primary power and the reserve power between the electrical load and an external power demand. The demand of the electrical load, the market price for electricity, the amount of reserve power, and the amount of primary power can be based, at least in part, on historical data.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A and 1B show diagrams of a system that includes integrated power supplies in accordance with certain example embodiments.

FIG. 2 shows a computing device in accordance with certain example embodiments.

FIG. 3 shows a detailed system that includes integrated power supplies in accordance with certain example embodiments.

FIGS. 4-8 each show a flowchart for controlling integrated power supplies in accordance with certain example embodiments.

### DETAILED DESCRIPTION

In general, example embodiments provide systems, methods, and devices for controlled distribution of integrated power supplies for electrical loads. While example embodiments are directed to electrical loads that include water heating, electrical loads can include any of a number of other devices used for any of a number of other purposes. Such other purposes can include, but are not limited to, HVAC, lighting, entertainment, sound, power distribution, security, laundry services, and cooking. Such other devices can include, but are not limited to, motors, light fixtures, heaters, televisions, computers, speakers, electrical outlets, and circuit breakers. Therefore, example embodiments should not be limited to use with electrical loads that include water heating.

Further, the various power supplies that are integrated using example embodiments can vary. While example embodiments described herein include PV solar systems and energy storage devices, example embodiments can additionally or alternatively include any of a number of other power supplies, including but not limited to system power, fuel cells, natural gas-fired generation, propane-fired generation, biomass generation, wind generators, and geothermal energy. As described herein, power that is sold from the integrated power supply (or portion thereof) can be defined as a number of components of power, including but not limited to generic electricity, ancillary components (e.g., capacity, reserves), and ancillary products (e.g., renewable energy credits (RECs)). When power is sold to an external power demand, the various components of the power can be completely bundled, partially bundled, or completely unbundled. For example, a certain number of kWhs of generic electricity, capacity, and reserves can be sold to one external power demand, and a corresponding number of RECs can be sold to another external power demand.

Example embodiments of stored power reserves can be used during an adverse operating condition (e.g., a fault, a power outage). In this way, one or more electrical loads can continue to receive power and operate during the adverse operating condition. In addition, or in the alternative, example embodiments can be used during normal operating conditions. In this way, example embodiments can be used to increase reliability and useful life of the electrical equipment, as well as improve the economic benefit of using example embodiments.

The example devices (or components thereof, including controllers) described herein can be made of one or more of a number of suitable materials to allow that device and/or other associated components of a system to meet certain standards and/or regulations while also maintaining durability in light of the one or more conditions under which the devices and/or other associated components of the system can be exposed. Examples of such materials can include, but are not limited to, aluminum, stainless steel, fiberglass, glass, plastic, ceramic, and rubber.

Example devices (or portions thereof) described herein can be made from a single piece (as from a mold, injection mold, die cast, or extrusion process). In addition, or in the alternative, example devices (or portions thereof) can be made from multiple pieces that are mechanically coupled to each other. In such a case, the multiple pieces can be mechanically coupled to each other using one or more of a number of coupling methods, including but not limited to epoxy, welding, soldering, fastening devices, compression fittings, mating threads, and slotted fittings. One or more pieces that are mechanically coupled to each other can be coupled to each other in one or more of a number of ways, including but not limited to fixedly, hingedly, removeably, slidably, and threadably.

In the foregoing figures showing example embodiments of controlled distribution of integrated power supplies for electrical loads, one or more of the components shown may be omitted, repeated, and/or substituted. Accordingly, example embodiments of controlled distribution of integrated power supplies for electrical loads should not be considered limited to the specific arrangements of components shown in any of the figures. For example, features shown in one or more figures or described with respect to one embodiment can be applied to another embodiment associated with a different figure or description.

In addition, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein. The numbering scheme for the various components in the figures herein is such that each component is a three digit number, and corresponding components in other figures have the identical last two digits.

In some cases, example embodiments can be subject to meeting certain standards and/or requirements. Examples of entities that set and/or maintain standards include, but are not limited to, the Department of Energy (DOE), the National Electric Code (NEC), the National Electrical Manufacturers Association (NEMA), the International Electrotechnical Commission (IEC), the Federal Communication Commission (FCC), the Illuminating Engineering Society (IES), and the Institute of Electrical and Electronics Engineers (IEEE). Use of example embodiments described herein meet (and/or allow a corresponding device to meet) such standards when required. In some (e.g., PV solar) applications, additional standards particular to that application may be met by the embodiments described herein.

Example embodiments of controlled distribution of integrated power supplies for electrical loads will be described more fully hereinafter with reference to the accompanying drawings, in which example embodiments of controlled distribution of integrated power supplies for electrical loads are shown. Controlled distribution of integrated power supplies for electrical loads may, however, be embodied in many different forms and should not be construed as limited to the example embodiments set forth herein. Rather, these example embodiments are provided so that this disclosure will be thorough and complete, and will fully convey the scope of controlled distribution of integrated power supplies for electrical loads to those of ordinary skill in the art. Like, but not necessarily the same, elements (also sometimes called components) in the various figures are denoted by like reference numerals for consistency.

Terms such as “first”, “second”, “third”, and “within” are used merely to distinguish one component (or part of a component or state of a component) from another. Such terms are not meant to denote a preference or a particular orientation, and are not meant to limit embodiments of controlled distribution of integrated power supplies for electrical loads. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

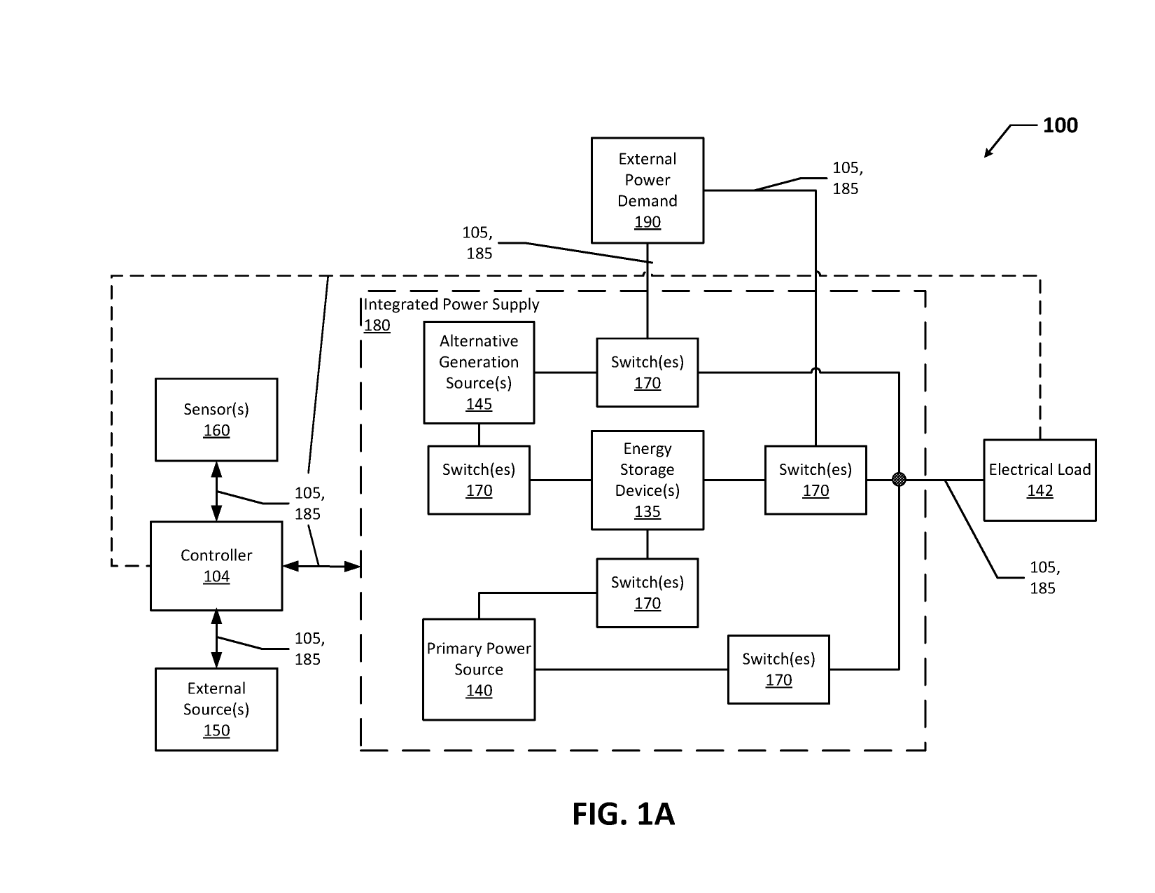

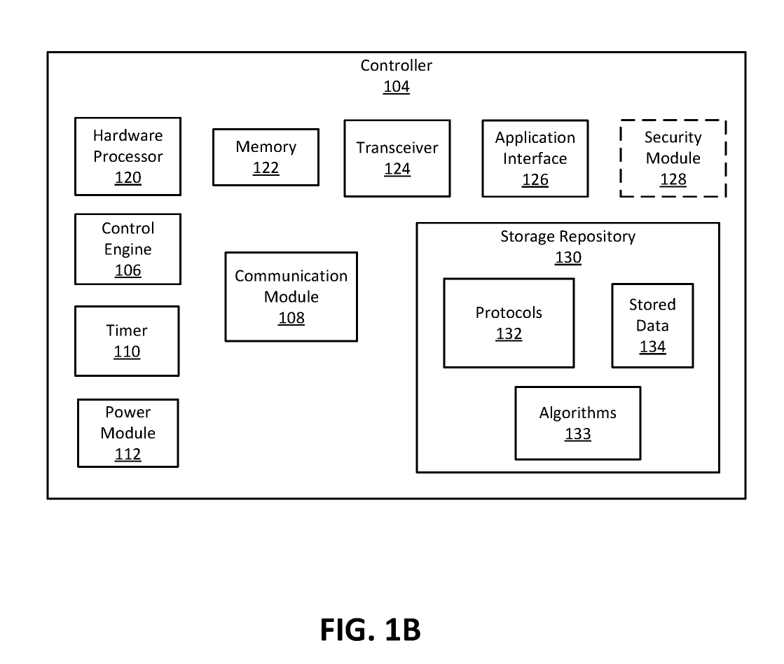

FIGS. 1A and 1B show diagrams of a system 100 that includes an integrated power supply 180 that is controlled by a controller 104 in accordance with certain example embodiments. Specifically, FIG. 1A shows the system 100, and FIG. 1B shows a detailed system diagram of the controller 104. As shown in FIGS. 1A and 1B, the system 100 can include one or more sensors 160 (also sometimes called sensor modules 160), one or more external sources 150, an external power demand 190, an electrical load 142, and the integrated power supply 180. The integrated power supply 180 can include a primary power source 140, one or more switches 170, one or more energy storage devices 135, and the alternative generation source 145.

As shown in FIG. 1B, the controller 104 can include one or more of a number of components. Such components, can include, but are not limited to, a control engine 106, a communication module 108, a timer 110, a power module 112, a storage repository 130, a hardware processor 120, a memory 122, a transceiver 124, an application interface 126, and, optionally, a security module 128. The components shown in FIGS. 1A and 1B are not exhaustive, and in some embodiments, one or more of the components shown in FIGS. 1A and 1B may not be included in an example system. Further, one or more components shown in FIGS. 1A and 1B can be rearranged. For example, one or more of the switches 170 can be part of the controller 104 of FIG. 1B rather than the integrated power supply 180 of FIG. 1A. Any component of the example system 100 can be discrete or combined with one or more other components of the system 100.

An external source 150 may be any person or entity that interacts with the integrated power supply 180 and/or the controller 104. Examples of an external source 150 may include, but are not limited to, an engineer, an electrician, an instrumentation and controls technician, a mechanic, an operator, a consultant, an electric utility, a grid operator, a retail electric provider, an energy marketing company, load forecasting software, a weather forecasting service, a network manager, a labor scheduling system, a contractor, a homeowner, a landlord, a building management company, and a manufacturer's representative. The external source 150 can use an external source system (not shown), which may include a display (e.g., a GUI). The external source 150 can interact with (e.g., sends data to, receives data from) the controller 104 via the application interface 126 (described below). The external source 150 can also interact with the electrical load 142, the external power demand 190, and/or one or more of the sensors 160. Interaction between the external source 150, the controller 104, the electrical load 142, the external power demand 190, and the sensors 160 is conducted using signal transfer links 105 and/or power transfer links 185.

Each signal transfer link 105 and each power transfer link 185 can include wired (e.g., Class 1 electrical cables, Class 2 electrical cables, electrical connectors, electrical conductors, electrical traces on a circuit board, power line carrier, DALI, RS485) and/or wireless (e.g., Wi-Fi, visible light communication, cellular networking, Bluetooth, WirelessHART, ISA100) technology. For example, a signal transfer link 105 can be (or include) one or more electrical conductors that are coupled to the controller 104 and to a sensor 160. A signal transfer link 105 can transmit signals (e.g., communication signals, control signals, data) between the controller 104, the external sources 150, integrated power supply 180, the external power demand 190, the electrical load 142, and/or one or more of the sensors 160. Similarly, a power transfer link 185 can transmit power between the controller 104, the external sources 150, integrated power supply 180, the external power demand 190, the electrical load 142, and/or one or more of the sensors 160. One or more signal transfer links 105 and/or one or more power transfer links 185 can also transmit signals and power, respectively, between components (e.g., energy storage devices 135, alternative generation source 145, switches 170) within the integrated power supply 180 and/or within the controller 104.

The external power demand 190 is an entity external of the electrical load 142 that consumes power. Examples of an external power demand 190 can include, but are not limited to, an electric utility, a grid operator, a retail electric provider, and an energy marketing company. In some cases, an external power demand can also be an external source 150. Also, in some cases, there can be more than one external power demand 190. The external power demand 190 can be passive or active. For example, when the external power demand 190 is passive, the external power demand 190 merely accepts power from the integrated power supply 180 without any other communication between the external power demand 190 and the rest of the system 100. As another example, when the external power demand 190 is active, the external power demand 190 can communicate with the controller 104 to provide a request (e.g., a bid price for power from the integrated power supply 180) for power from the integrated power supply 180. In such a case, there can be two-way communication between the external power demand 190 and the controller 104 before power is released from the integrated power supply 180 to the external power demand 190.

In some cases, the external power demand 190 can also be an external source 150 such as, for example, an independent transmission system operator (e.g., PJM, Midwest Independent System Operator (ISO), California ISO, Electric Reliability Council of Texas (ERCOT)) that posts real-time electricity pricing and, in some cases, pricing for ancillary services (e.g., reserves, capacity) and/or ancillary products (e.g., RECs). These prices can be zonal or even locational to include the location of the integrated power supply. By providing the pricing information, the independent system operator is an external source 150, and by receiving and clearing the power and/or other ancillary services, the independent system operator is an external power demand 190.

The one or more sensors 160 can be any type of sensing device that measures one or more parameters. Examples of types of sensors 160 can include, but are not limited to, a resistor, a Hall Effect current sensor, a thermistor, a vibration sensor, an accelerometer, a passive infrared sensor, a photocell, a voltmeter, an ammeter, a power meter, an ohmmeter, an electric power meter, and a resistance temperature detector. A sensor 160 can also include one or more components and/or devices (e.g., a potential transformer, a current transformer, electrical wiring) related to the measurement of a parameter.

A parameter that can be measured by a sensor 160 can include, but is not limited to, current, voltage, power, resistance, available storage capacity, vibration, position, and temperature. In some cases, the parameter or parameters measured by a sensor 160 can be used by the controller 104 to operate one or more of the switches 170. Each sensor 160 can use one or more of a number of communication protocols. A sensor 160 can be a stand-alone device or integrated with another component (e.g., the energy storage devices 135) in the system 100. A sensor 160 can measure a parameter continuously, periodically, based on the occurrence of an event, based on a command received from the control module 106, and/or based on some other factor.

In certain example embodiments, the electrical load 142 includes one or more devices (or components thereof) that consume electricity during operation. Examples of an electrical load 142 can include, but are not limited to, a traditional electric or gas tank water heater, a stacked tank water heater, a series of tank water heaters, single or stacked tankless water heaters, a motor, a heating element, a HVAC system (or components thereof), a phone system, a security system, lighting, electrical outlets, computer equipment, and appliances (e.g., washing machine, dryer, dishwasher, refrigerator, freezer).

In some cases, one or more devices of the electrical load 142 can have their own local controller. In such a case, the controller 104 can communicate with the local controller of the electrical load 142 using signal transfer links 105 and/or power transfer links 185. The electrical load 142 can be located in, on, or proximate to a building or structure (e.g., residential home, office building, warehouse, manufacturing plant). In addition, or in the alternative, the electrical load 142 can be located remotely from a building or structure. For example, the electrical load 142 can include lighting for a large parking lot at a shopping mall.

The external sources 150, the integrated power supply 180, the external power demand 190, the electrical load 142, and/or the sensors 160 can interact with the controller 104 using the application interface 126 in accordance with one or more example embodiments. Specifically, the application interface 126 of the controller 104 receives data (e.g., information, communications, instructions, updates to firmware) from and sends data (e.g., information, communications, instructions) to each external source 150, the integrated power supply 180, the external power demand 190, the electrical load 142, and/or each sensor 160. The external source 150, the integrated power supply 180, the external power demand 190, the electrical load 142, and/or each sensor 160 can include an interface to receive data from and send data to the controller 104 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

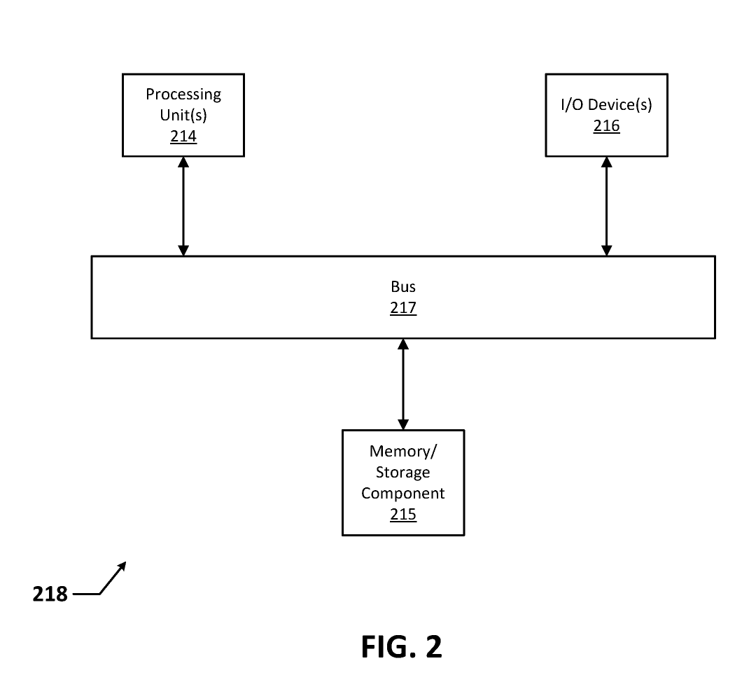

The controller 104, the external source 150, the integrated power supply 180, the external power demand 190, the electrical load 142, and/or the sensors 160 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 104. Examples of such a system can include, but are not limited to, a desktop computer with LAN, WAN, Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 2.

Further, as discussed above, such a system can have corresponding software (e.g., external source software, sensor software, external power demand software, electrical load software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, Local Area Network (LAN), Wide Area Network (WAN), or other network communication methods) and/or communication channels, with wire and/or wireless segments according to some example embodiments. The software of one system can be a part of, or operate separately but in conjunction with, the software of another system within the system 100.

The controller 104 can be a stand-alone device or integrated with another component (e.g., the electrical load 142) in the system 100. When the controller 104 is a stand-alone device, the controller 104 can include a housing. In such a case, the housing can include at least one wall that forms a cavity. In some cases, the housing can be designed to comply with any applicable standards so that the controller 104 can be located in a particular environment (e.g., a hazardous environment, a high temperature environment, a high humidity environment).

The housing of the controller 104 can be used to house one or more components of the controller 104. For example, the controller 104 (which in this case includes the control engine 106, the communication module 108, the timer 110, the power module 112, the storage repository 130, the hardware processor 120, the memory 122, the transceiver 124, the application interface 126, and the optional security module 128) can be disposed in a cavity formed by a housing. In alternative embodiments, any one or more of these or other components of the controller 104 can be disposed on a housing and/or remotely from a housing.

The storage repository 130 can be a persistent storage device (or set of devices) that stores software and data used to assist the controller 104 in communicating with the external source 150, the integrated power supply 180, the external power demand 190, the electrical load 142, and one or more sensors 160 within the system 100. In one or more example embodiments, the storage repository 130 stores one or more protocols 132, algorithms 133, and stored data 134. The protocols 132 can be any procedures (e.g., a series of method steps) and/or other similar operational procedures that the control engine 106 of the controller 104 follows based on certain conditions at a point in time. The protocols 132 can include any of a number of communication protocols 132 that are used to send and/or receive data between the controller 104 and the external source 150, the integrated power supply 180, the external power demand 190, the electrical load 142, and one or more sensors 160.

A protocol 132 can be used for wired and/or wireless communication. Examples of a protocol 132 can include, but are not limited to, Modbus, profibus, Ethernet, and fiberoptic. One or more of the communication protocols 132 can be a time-synchronized protocol. Examples of such time-synchronized protocols can include, but are not limited to, a highway addressable remote transducer (HART) protocol, a wireless HART protocol, and an International Society of Automation (ISA) 100 protocol. In this way, one or more of the communication protocols 132 can provide a layer of security to the data transferred within the system 100.

The algorithms 133 can be any formulas, logic steps, mathematical models (e.g., load forecasting models, forward energy price model), and/or other suitable means of manipulating and/or processing data. One or more algorithms 133 can be used for a particular protocol 132. As discussed above, the controller 104 controls one or more of the switches 170 in certain example embodiments. The controller 104 can base its control of a switch 170 using a protocol 132, an algorithm 133, and/or stored data 134. For example, a protocol 132 can dictate the length of a period of time (e.g., measured by the timer 110) where the primary power source 140 and/or the alternative generation source 145 provide primary power to the energy storage devices 135. As another example, an algorithm 133 can be used, in conjunction with measurements made by one or more sensors 160, to determine how often one or more switches 170 are operated.

As another example, an algorithm 133 can be directed to generating a forecast of a parameter (e.g., weather, demand of the electrical load 142, generating capability of an alternative generation source 145). This forecast parameter can be based on historical data (stored as stored data 134). For example, an algorithm 133 can be used to forecast balancing the market price for power, a demand curve for the electrical load 142, the level of storage in the energy storage devices 135, the generation forecast for the alternative generation source 145, the weather forecast, and/or any other suitable factors to determine the desired position of each of the switches 170. In some cases, a protocol 132 can be used to operate one or more of the switches 170 based on some other factor, including but not limited to a passage of time.

Stored data 134 can be any data associated with the system 100 (including any components thereof), any measurements taken by the sensors 160, time measured by the timer 110, threshold values, power price information, load forecast information, current ratings for the energy storage devices 135, results of previously run or calculated algorithms 133, and/or any other suitable data. Such data can be any type of data, including but not limited to historical data for the system 100 (including any components thereof, such as the energy storage devices 135 and the electrical load 142), historical data for other energy storage devices not part of the integrated power supply 180, historical load and pricing information, calculations, and measurements taken by one or more sensors 160. The stored data 134 can be associated with some measurement of time derived, for example, from the timer 110.

Examples of a storage repository 130 can include, but are not limited to, a database (or a number of databases), a file system, a hard drive, flash memory, some other form of solid state data storage, or any suitable combination thereof. The storage repository 130 can be located on multiple physical machines, each storing all or a portion of the protocols 132, the algorithms 133, and/or the stored data 134 according to some example embodiments. Each storage unit or device can be physically located in the same or in a different geographic location.

The storage repository 130 can be operatively connected to the control engine 106. In one or more example embodiments, the control engine 106 includes functionality to communicate with the external source 150, the integrated power supply 180, the external power demand 190, the electrical load 142, and the sensors 160 in the system 100. More specifically, the control engine 106 sends information to and/or receives information from the storage repository 130 in order to communicate with the external source 150, the integrated power supply 180, the external power demand 190, the electrical load 142, and the sensors 160. As discussed below, the storage repository 130 can also be operatively connected to the communication module 108 in certain example embodiments.

In certain example embodiments, the control engine 106 of the controller 104 controls the operation of one or more components (e.g., the communication module 108, the timer 110, the transceiver 124) of the controller 104. For example, the control engine 106 can activate the communication module 108 when the communication module 108 is in “sleep” mode and when the communication module 108 is needed to send data received from another component (e.g., switches 170, a sensor 160, the external source 150) in the system 100.

As another example, the control engine 106 can acquire the current time using the timer 110. The timer 110 can enable the controller 104 to control the integrated power supply 180 (including any components thereof, such as the primary power source 140 and one or more switches 170). As yet another example, the control engine 106 can direct a sensor 160 to measure and send power consumption information of an energy storage device 135 to the controller 104. In some cases, the control engine 106 of the controller 104 can control the position (e.g., open, closed) of each switch 170, which causes a particular power source (in this example, the alternative generation source 145, the primary power source 140, and one or more of the energy storage devices 135) to provide power to the electrical load 142 and/or the external power demand 190.

The control engine 106 can be configured to perform a number of functions that control which integrated power supply 180 provides power to the electrical load 142 in the system 100. Specifically, the control engine 106 can control the position of each of the switches 170, thereby controlling what part of the integrated power supply 180 provides power to the electrical load 142 at a particular point in time.

For example, the control engine 106 can execute any of the protocols 132 and/or algorithms 133 stored in the storage repository 130 and use the results of those protocols 132 and/or algorithms 133 to change the position of one or more switches 170. As a specific example, the control engine 106 can measure (using a sensor 160), store (as stored data 134 in the storage repository 130), and evaluate, using an algorithm 133, the level of storage of each energy storage device 135 at a particular point in time. In this way, the controller 104 can use this information to help decide when reserve power from the energy storage devices 135 can be released to the electrical load 142 and/or the external power demand 190. As another specific example, the control engine 106 can determine, based on measurements made by one or more sensors 160, whether an energy storage device 135 has failed. In such a case, the control engine 106 can change the position of one or more switches 170 to bypass the energy storage device 135 that failed.

The control engine 106 can generate an alarm when an operating parameter (e.g., total number of operating hours, number of consecutive operating hours, number of operating hours delivering power above a current level, input power quality, vibration, operating ambient temperature, operating device temperature, and cleanliness (e.g., air quality, fixture cleanliness)) of one or more components of the system 100 exceeds a threshold value, indicating possible present or future failure of such component. The control engine 106 can further measure (using one or more sensors 160) and analyze the magnitude and number of surges that the electrical load 142, the alternative generation source 145, the primary power source 140, and/or the energy storage devices 135 are subjected to over time.

Using one or more algorithms 133, the control engine 106 can predict the expected useful life of these components based on stored data 134, a protocol 132, one or more threshold values, and/or some other factor. The control engine 106 can also measure (using one or more sensors 160) and analyze the efficiency of the alternative generation source 145, the energy storage devices 135, and/or the electrical load 142 over time. An alarm can be generated by the control engine 106 when the efficiency of a component of the system 100 falls below a threshold value, indicating failure of that component.

If the control engine 106 determines that power from one or more of the integrated power supply 180 can be sold to the external power demand 190 for a profit, the control engine 106 can curtail and/or alter the operation of one or more portions of the electrical load 142. For example, if power generated by one or more of the integrated power supply 180 is being sold to the external power demand 190, and if the control engine 106 is being aggressive as to the amount of power that it is selling relative to the demand of the electrical load 142, the control engine 106 can prohibit the operation of certain components (e.g., HVAC) of the electrical load 142 for a certain period of time (e.g., until 9:00 p.m.), and the control engine 106 can prohibit the thermostat from being lowered beyond 76° F. until a certain point of time (e.g., 10:00 p.m.).

As discussed above, the control engine 106 of the controller 104 uses information from one or more external sources 150, the sensors 160, the integrated power supply 180, the electrical load 142, the external power demand 180, and/or the storage repository 130 to determine when power from the integrated power supply 180 can be sold to the external power demand 190 and, if so, which parts of the integrated power supply 180 provide power to the electrical load 142 and which parts of the integrated power supply 180 provide power to the external power demand 180. The external sources 150 can provide information that can include, but is not limited to, actual and forecast weather data, actual and forecast demand external to the system 100 (e.g., in the local distribution grid), actual and forecast demand of the electrical load 142, actual and forward pricing of wholesale electricity (ideally, at the location of the transmission or distribution grid in which the electrical load 142 is located), actual and forecast occupancy of the building served by the electrical load 142, information about the actual and forecast occupants of the building, the current and forward price of natural gas, the price of propane, the amount of propane in storage, and historical information for any of the foregoing.

Using historical data (a form of stored data 134) and the information provided by the external sources 150, the control engine 106 can predict or forecast one or more parameters (e.g., weather, demand, power prices). Based on these forecast parameters, the control engine 106 can determine when and how much power should be sold to the external power demand 180. As part of the decision to sell power to the external power demand 180, the control engine 106 can change the operation of the electrical load 142 and/or the integrated power supply 180. Based on the decisions made by the control engine 106, the control engine 106 controls one or more of the switches 170 to allow power from each power source of the integrated power supply 180 to flow to a desired end user (e.g., the electrical load 142, the external power demand 190).

The control engine 106 can perform this evaluation function and resulting actions on a continuous basis, periodically, during certain time intervals, or randomly. Further, the control engine 106 can perform this evaluation for the present time or for a period of time in the future. For example, the control engine 106 can perform forecasts of parameters such as demand of the electrical load 142, output of the integrated power supply 180, and market price for power to be paid by the external power demand 180 six hours into the future. The control engine 106 can then adjust these forecasts (e.g., every hour, when new information from an external source 150 is received) until the six hour window has closed.

The control engine 106 can manage the sale of power to the external power demand 180. For example, the control engine 106 can identify an external power demand 180 that is willing to buy power, negotiate a price for the power, and execute a contract for sale of the power to the external power demand 180. In such a case, the control engine 106 can determine whether the power should be sold as firm or non-firm, the quantity of power to be sold, and the period of delivery (e.g., one hour, on-peak daily schedule) of sale.

When there are multiple buyers among the external power demand 180, the control engine 106 can select a particular buyer in one or more of a number of ways. For example, the control engine 106 can select a buyer among multiple interested parties in the external power demand 180 by merely determining the highest price for a particular period of time. When the period of delivery and/or other terms vary among multiple interested parties in the external power demand 180, the control engine 106 can select the terms that are most favorable in view of the forecast information (e.g., demand of the electrical load 142 over time, output of the integrated power supply 180 over time, degree of confidence in the forecasts).

As another example, when there are multiple interested parties among the external power demand 180, the control engine 106 can have an auction process and/or facilitate a request for proposals. This auction process can be conducted in real time. The request for proposals can be sent out at any time and can be for any term. In any case, when power is sold to an external power demand 180, the control engine 106 is capable of retrieving (from the storage repository 130) and executing the sale of the power under the terms (e.g., force majeure clause) of the agreement in place with that particular external power demand 180.

The control engine 106 can provide power, control, communication, and/or other similar signals to the external source 150, the integrated power supply 180, the external power demand 190, the electrical load 142, and one or more of the sensors 160. Similarly, the control engine 106 can receive power, control, communication, and/or other similar signals from the external source 150, the integrated power supply 180, the external power demand 190, the electrical load 142, and one or more of the sensors 160. The control engine 106 can control each sensor 160 automatically (for example, based on one or more algorithms 133 stored in the storage repository 130) and/or based on power, control, communication, and/or other similar signals received from another device through a signal transfer link 105 and/or a power transfer link 185. The control engine 106 may include a printed circuit board, upon which the hardware processor 120 and/or one or more discrete components of the controller 104 are positioned.

In certain embodiments, the control engine 106 of the controller 104 can communicate with one or more components of a system external to the system 100 in furtherance of optimizing the various integrated power supply 180 in the system 100. For example, the control engine 106 can interact with an inventory management system by ordering a component (e.g., an energy storage device 135) to replace an energy storage device 135 that the control engine 106 has determined has failed or is failing. As another example, the control engine 106 can interact with a workforce scheduling system by scheduling a maintenance crew to repair or replace an energy storage device 135 when the control engine 106 determines that the energy storage device 135 requires maintenance or replacement. In this way, the controller 104 is capable of performing a number of functions beyond what could reasonably be considered a routine task.

In certain example embodiments, the control engine 106 can include an interface that enables the control engine 106 to communicate with one or more components (e.g., an external source 150, a switch 170) of the system 100. For example, if an external source 150 operates under IEC Standard 62386, then the external source 150 can have a serial communication interface that will transfer data (e.g., stored data 134) measured by the sensors 160. In such a case, the control engine 106 can also include a serial interface to enable communication with the external source 150. Such an interface can operate in conjunction with, or independently of, the protocols 132 used to communicate between the controller 104 and the external source 150, the integrated power supply 180, the external power demand 190, the electrical load 142, and the sensors 160.

The control engine 106 (or other components of the controller 104) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

The communication module 108 of the controller 104 determines and implements the communication protocol (e.g., from the protocols 132 of the storage repository 130) that is used when the control engine 106 communicates with (e.g., sends signals to, receives signals from) the external source 150, the integrated power supply 180, the external power demand 190, the electrical load 142, and/or one or more of the sensors 160. In some cases, the communication module 108 accesses the stored data 134 to determine which communication protocol is used to communicate with the sensor 160 associated with the stored data 134. In addition, the communication module 108 can interpret the communication protocol of a communication received by the controller 104 so that the control engine 106 can interpret the communication.

The communication module 108 can send and receive data between the integrated power supply 180, the external power demand 190, the electrical load 142, the sensors 160, and/or the external sources 150 and the controller 104. The communication module 108 can send and/or receive data in a given format that follows a particular protocol 132. The control engine 106 can interpret the data packet received from the communication module 108 using the protocol 132 information stored in the storage repository 130. The control engine 106 can also facilitate the data transfer between one or more sensors 160, the integrated power supply 180, the external power demand 190, the electrical load 142, and an external source 150 by converting the data into a format understood by the communication module 108.

The communication module 108 can send data (e.g., protocols 132, algorithms 133, stored data 134, operational information, alarms) directly to and/or retrieve data directly from the storage repository 130. Alternatively, the control engine 106 can facilitate the transfer of data between the communication module 108 and the storage repository 130. The communication module 108 can also provide encryption to data that is sent by the controller 104 and decryption to data that is received by the controller 104. The communication module 108 can also provide one or more of a number of other services with respect to data sent from and received by the controller 104. Such services can include, but are not limited to, data packet routing information and procedures to follow in the event of data interruption.

The timer 110 of the controller 104 can track clock time, intervals of time, an amount of time, and/or any other measure of time. The timer 110 can also count the number of occurrences of an event, whether with or without respect to time. Alternatively, the control engine 106 can perform the counting function. The timer 110 is able to track multiple time measurements concurrently. The timer 110 can track time periods based on an instruction received from the control engine 106, based on an instruction received from the external source 150, based on an instruction programmed in the software for the controller 104, based on some other condition or from some other component, or from any combination thereof.

The timer 110 can be configured to track time when there is no power delivered to the controller 104 (e.g., the power module 112 malfunctions) using, for example, a super capacitor or a battery backup. In such a case, when there is a resumption of power delivery to the controller 104, the timer 110 can communicate any aspect of time to the controller 104. In such a case, the timer 110 can include one or more of a number of components (e.g., a super capacitor, an integrated circuit) to perform these functions.

The power module 112 of the controller 104 provides power to one or more other components (e.g., timer 110, control engine 106) of the controller 104. In addition, in certain example embodiments, the power module 112 can provide power to one or more components (e.g., the energy storage devices 135) of the integrated power supply 180. The power module 112 can include one or more of a number of single or multiple discrete components (e.g., transistor, diode, resistor), and/or a microprocessor. The power module 112 may include a printed circuit board, upon which the microprocessor and/or one or more discrete components are positioned. In some cases, the power module 112 can include one or more components that allow the power module 112 to measure one or more elements of power (e.g., voltage, current) that is delivered to and/or sent from the power module 112. Alternatively, the controller 104 can include a power metering module (not shown) to measure one or more elements of power that flows into, out of, and/or within the controller 104.

The power module 112 can include one or more components (e.g., a transformer, a diode bridge, an inverter, a converter) that receives power (for example, through an electrical cable) from a source (e.g., the primary power source 140) external to the controller 104 and generates power of a type (e.g., AC, DC) and level (e.g., 12V, 24V, 120V) that can be used by the other components of the controller 104 and/or by the primary power source 140. The power module 112 can use a closed control loop to maintain a preconfigured voltage or current with a tight tolerance at the output. The power module 112 can also protect the remainder of the electronics (e.g., hardware processor 120, transceiver 124) in the controller 104 from surges generated in the line.

In addition, or in the alternative, the power module 112 can be a source of power in itself to provide signals to the other components of the controller 104. For example, the power module 112 can be a battery. As another example, the power module 112 can be a localized photovoltaic power system. The power module 112 can also have sufficient isolation in the associated components of the power module 112 (e.g., transformers, opto-couplers, current and voltage limiting devices) so that the power module 112 is certified to provide power to an intrinsically safe circuit.

In certain example embodiments, the power module 112 of the controller 104 can also provide power and/or control signals, directly or indirectly, to one or more of the sensors 160. In such a case, the control engine 106 can direct the power generated by the power module 112 to one or more of the sensors 160. In this way, power can be conserved by sending power to the sensors 160 when those devices need power, as determined by the control engine 106.

The hardware processor 120 of the controller 104 executes software, algorithms, and firmware in accordance with one or more example embodiments. Specifically, the hardware processor 120 can execute software on the control engine 106 or any other portion of the controller 104, as well as software used by the external source 150, the integrated power supply 180, the external power demand 190, the electrical load 142, and/or one or more of the sensors 160. The hardware processor 120 can be an integrated circuit, a central processing unit, a multi-core processing chip, SoC, a multi-chip module including multiple multi-core processing chips, or other hardware processor in one or more example embodiments. The hardware processor 120 is known by other names, including but not limited to a computer processor, a microprocessor, and a multi-core processor.

In one or more example embodiments, the hardware processor 120 executes software instructions stored in memory 122. The memory 122 includes one or more cache memories, main memory, and/or any other suitable type of memory. The memory 122 can include volatile and/or non-volatile memory. The memory 122 is discretely located within the controller 104 relative to the hardware processor 120 according to some example embodiments. In certain configurations, the memory 122 can be integrated with the hardware processor 120.

In certain example embodiments, the controller 104 does not include a hardware processor 120. In such a case, the controller 104 can include, as an example, one or more field programmable gate arrays (FPGA), one or more insulated-gate bipolar transistors (IGBTs), and one or more integrated circuits (ICs). Using FPGAs, IGBTs, ICs, and/or other similar devices known in the art allows the controller 104 (or portions thereof) to be programmable and function according to certain logic rules and thresholds without the use of a hardware processor. Alternatively, FPGAs, IGBTs, ICs, and/or similar devices can be used in conjunction with one or more hardware processors 120.

The transceiver 124 of the controller 104 can send and/or receive control and/or communication signals. Specifically, the transceiver 124 can be used to transfer data between the controller 104 and the external source 150, the integrated power supply 180, the external power demand 190, the electrical load 142, and/or the sensors 160. The transceiver 124 can use wired and/or wireless technology. The transceiver 124 can be configured in such a way that the control and/or communication signals sent and/or received by the transceiver 124 can be received and/or sent by another transceiver that is part of the external source 150, the integrated power supply 180, the external power demand 190, the electrical load 142, and/or the sensors 160. The transceiver 124 can use any of a number of signal types, including but not limited to radio signals.

When the transceiver 124 uses wireless technology, any type of wireless technology can be used by the transceiver 124 in sending and receiving signals. Such wireless technology can include, but is not limited to, Wi-Fi, visible light communication, cellular networking, and Bluetooth. The transceiver 124 can use one or more of any number of suitable communication protocols (e.g., ISA100, HART) when sending and/or receiving signals. Such communication protocols can be stored in the communication protocols 132 of the storage repository 130. Further, any transceiver information for the external source 150, the integrated power supply 180, the external power demand 190, the electrical load 142, and/or the sensors 160 can be part of the stored data 134 (or similar areas) of the storage repository 130.

Optionally, in one or more example embodiments, the security module 128 secures interactions between the controller 104, the external source 150, the integrated power supply 180, the external power demand 190, the electrical load 142, and/or the sensors 160. More specifically, the security module 128 authenticates communication from software based on security keys verifying the identity of the source of the communication. For example, external source software may be associated with a security key enabling the software of the external source 150 to interact with the controller 104 and/or the sensors 160. Further, the security module 128 can restrict receipt of information, requests for information, and/or access to information in some example embodiments.

The primary power source 140 of the integrated power supply 180 can provide power to the electrical load 142. The primary power source 140 is a source of power that conventionally provides power to a building or other structure. The primary power source 140 is often metered when entering a building or other structure, and is often distributed using a fuse box, junction box, and/or similar enclosure. The primary power source 140 can include one or more of a number of single or multiple discrete components (e.g., transistor, diode, resistor), and/or a microprocessor. The primary power source 140 may include a printed circuit board, upon which the microprocessor and/or one or more discrete components are positioned. The primary power source 140 can include signal transfer links 105 and/or power transfer links 185.

A primary power source 140 can include one or more components (e.g., a transformer, a diode bridge, an inverter, a converter) that generates power of a type (e.g., AC, DC) and level (e.g., 12V, 24V, 120V) that can be used by the electrical load 142. In addition, or in the alternative, the primary power source 140 can receive power from a source external to the system 100. In addition, or in the alternative, the primary power source 140 can be a source of power in itself. For example, the primary power source 140 can be a battery, a localized photovoltaic power system, or some other source of independent power. In some cases, the primary power source 140 is optional, and so at times (e.g., when a building is “off the grid”) the primary power source 140 is not included in the integrated power supply 180.

The alternative generation source 145 includes one or more sources of alternative power. The alternative generation source 145 can include one or more PV solar panels and related equipment, including but not limited to one or more inverters, cord connectors, cables, fuses, batteries, and transformers. In addition, or in the alternative, the alternative generation source 145 can include one or more other sources of alternative generation, including but not limited to small scale wind generators, geothermal generation, heat pumps, micro-generators powered by waste gas, standby generators (operating, for example, using propane or natural gas), micro-generation using solar thermal technology, and fuel cells. These alternative generation sources 145 can be located on a building, within a building, and/or proximate to a building. An alternative generation source 145 is designed to operate at least substantially independent of other sources of power, such as the primary power source 140.

The energy storage devices 135 can be any number of rechargeable devices (e.g., batteries, supercapacitors) that are configured to charge using primary power provided by the alternative generation source 145 and/or the power (sometimes called secondary power herein) provided by the primary power source 140. In some cases, an energy storage device 135 charges using a different level and/or type of power relative to the level and type of power of the primary power. There can be any number (e.g., one, two, five) of energy storage devices 135. The energy storage devices 135 can use one or more of any number of battery technologies. Examples of such technologies can include, but are not limited to, nickel-cadmium, nickel-metalhydride, lithium-ion, and alkaline. Aside from a battery, an energy storage device 135 can take on any of a number of other forms known in the art. For example, an energy storage device 135 can include one or more supercapacitors.

Each switch 170 can be any type of device that changes state or position (e.g., opens, closes) based on certain conditions. Examples of a switch 170 can include, but are not limited to, a transistor, a dipole switch, a tripole switch, a relay contact, a resistor, and a NOR gate. In certain example embodiments, each switch 170 can operate (e.g., change from a closed position to an open position, change from an open position to a closed position) based on input from the controller 104.

FIG. 2 illustrates one embodiment of a computing device 218 that implements one or more of the various techniques described herein, and which is representative, in whole or in part, of the elements described herein pursuant to certain example embodiments. Computing device 218 is one example of a computing device and is not intended to suggest any limitation as to scope of use or functionality of the computing device and/or its possible architectures. Neither should computing device 218 be interpreted as having any dependency or requirement relating to any one or combination of components illustrated in the example computing device 218.

Computing device 218 includes one or more processors or processing units 214, one or more memory/storage components 215, one or more input/output (I/O) devices 216, and a bus 217 that allows the various components and devices to communicate with one another. Bus 217 represents one or more of any of several types of bus structures, including a memory bus or memory controller, a peripheral bus, an accelerated graphics port, and a processor or local bus using any of a variety of bus architectures. Bus 217 includes wired and/or wireless buses.

Memory/storage component 215 represents one or more computer storage media. Memory/storage component 215 includes volatile media (such as random access memory (RAM)) and/or nonvolatile media (such as read only memory (ROM), flash memory, optical disks, magnetic disks, and so forth). Memory/storage component 215 includes fixed media (e.g., RAM, ROM, a fixed hard drive, etc.) as well as removable media (e.g., a flash memory drive, a removable hard drive, an optical disk, and so forth).

One or more I/O devices 216 allow a customer, utility, or other user to enter commands and information to computing device 218, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 is connected to a network (not shown) (e.g., a local area network (LAN), a wide area network (WAN) such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain example embodiments. Further, one or more embodiments is implemented on a distributed system having one or more nodes, where each portion of the implementation (e.g., control engine 106) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

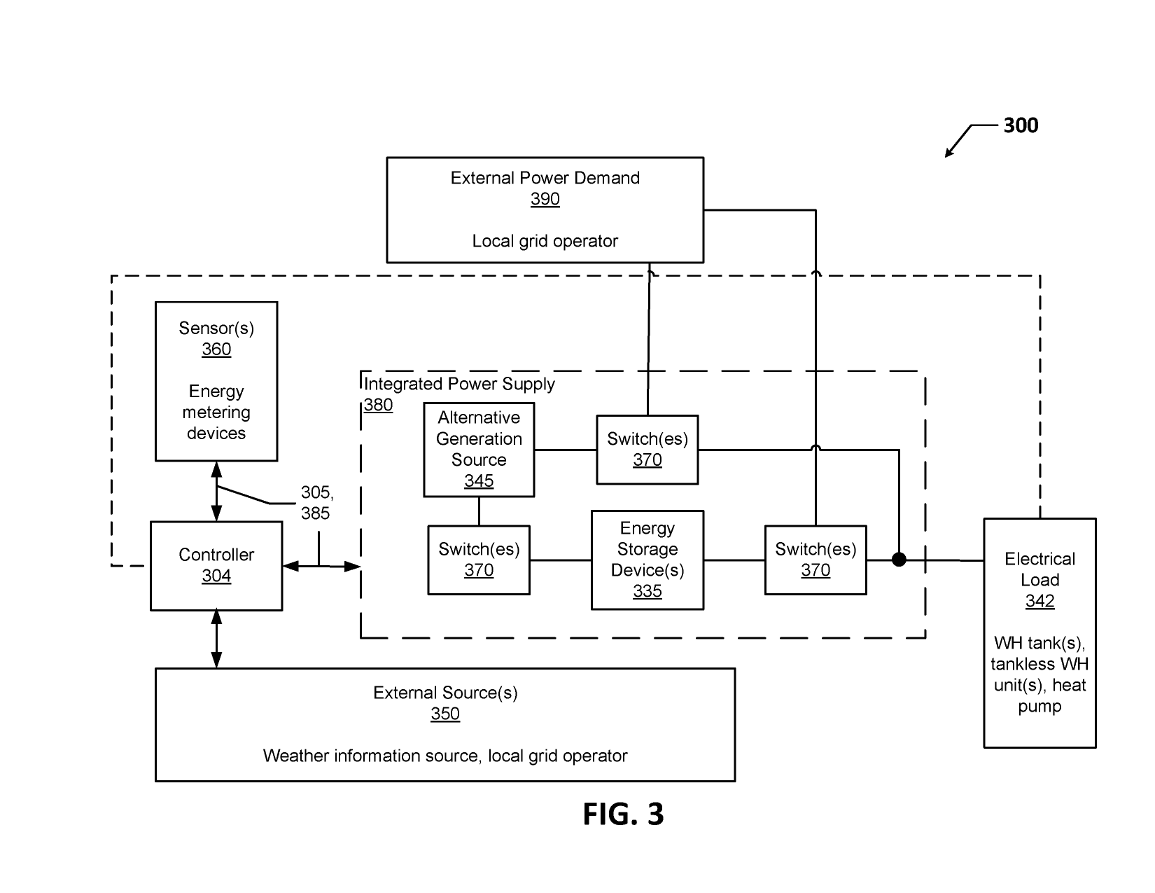

FIG. 3 shows a detailed system 300 that includes an integrated power supply 380 in accordance with certain example embodiments. Referring to FIGS. 1A-3, the system 300 of FIG. 3 (including its various components) is substantially the same as the system 100 of FIGS. 1A and 1B, except as described below. The system 300 of FIG. 3 includes an external power demand 390 (which in this case is a local grid operator), an electrical load 342 (such as an electric water heater, a tankless water heater, and/or a heat pump), sensors 360 (which in this case are energy metering devices), a controller 304, multiple external sources 350 (which in this case is a weather information source and a local grid operator), and an integrated power supply 380 (which in this case includes an alternative generation source 345 (which in this case is a PV solar generation source), energy storage device 335, and a number of switches 370). The integrated power supply 380 in this case does not include a primary power source.

The controller 304 in this example includes load forecasting software and optimization software that makes decisions based on actual and forecast market pricing (provided by the external sources 350) in light of the time of day/week (provided by the timer of the controller 304), retail rate structure (stored in the storage repository of the controller 304), demand and energy consumption of the load 342 (stored in the storage repository of the controller 304), and capabilities of the PV solar generation 345 and the energy storage devices 335 (stored in the storage repository of the controller 304).

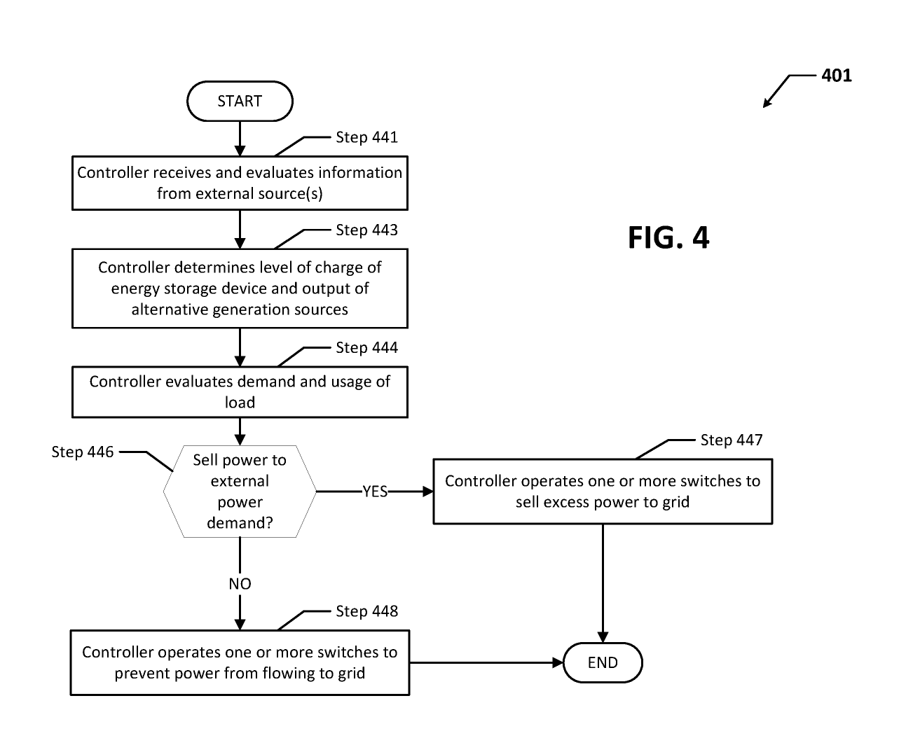

FIGS. 4-8 each show a flowchart for controlling integrated power supplies in accordance with certain example embodiments. While the various steps in these flowcharts are presented and described sequentially, one of ordinary skill in the art will appreciate that some or all of the steps are executed in different orders, combined or omitted, and some or all of the steps are executed in parallel depending upon the example embodiment. Further, in one or more of the example embodiments, one or more of the steps described below are omitted, repeated, and/or performed in a different order. In addition, a person of ordinary skill in the art will appreciate that additional steps not shown in FIGS. 4-8 can be included in performing these methods in certain example embodiments.

Accordingly, the specific arrangement of steps should not be construed as limiting the scope. In addition, a particular computing device, as described, for example, in FIG. 2 above, is used to perform one or more of the steps for the methods described below in certain example embodiments. For the methods described below, unless specifically stated otherwise, a description of the controller 104 performing certain functions can be applied to the control engine 106 of the controller 104.

Referring to FIGS. 1A-8, the example method 401 of FIG. 4 begins at the START step and proceeds to step 441, where the controller 104 receives and evaluates information from one or more external sources 150. Such information can be any information that can help the controller 104 decide if and when power from one or more sources (e.g., energy storage devices 135, alternative generation sources 145) of the integrated power supply 180 should be sold to the external power demand 190. Such information can include, but is not limited to, actual and forecast weather data, actual and forecast demand external to the system 100 (e.g., in the local distribution grid), actual and forecast demand of the electrical load 142, actual and forward pricing of wholesale electricity (ideally, at the location of the transmission or distribution grid in which the electrical load 142 is located), actual and forecast occupancy of the building served by the electrical load 142, information about the actual and forecast occupants of the building, the current and forward price of natural gas, the price of propane, the amount of propane in storage, and historical information for any of the foregoing.

In some cases, the controller 104 can send a request for information to one or more external sources 150. Alternatively, one or more external sources 150 can send information to the controller 104 based on some other condition (e.g., passage of time, occurrence of an event). Communications between the controller 104 and the external sources 150 can be facilitated using signal transfer links 105 and/or power transfer links 185.

In step 442 the controller 104 determines a level of charge of the energy storage devices 135 and an output of the alternative generation sources 145. The controller 104 can make this determination using one or more sensors 160. In such a case, a sensor 160 can be an energy metering device (e.g., a voltmeter, an ammeter). The output of the one or more alternative generation sources 145 can be for current output and/or forecasted output based on one or more conditions (e.g., weather forecast) provided by an external source 150. The controller 104 can also make this determination using one or more algorithms 133.

In step 444, the controller 104 evaluates the demand and usage of the electrical load 142. The demand can correspond to an instantaneous peak demand for power, while the usage can correspond to the amount of power (e.g., kWh) consumed by the electrical load 142 over some period of time. The demand and usage of the electrical load 142 can be determined and evaluated using, for example, one or more sensors 160, historical information (e.g., stored data 134), and/or one or more algorithms 133.

Based on the information, determinations, and evaluations made in the above-described steps, a determination is made as to whether power should be sold to the external power demand 190. If power is sold to the external power demand 190, then the method 401 proceeds to step 447, where the controller 104 operates one or more switches 170 to allow power to flow from the integrated power supply 180 to the external power demand 190. If power is not sold to the external power demand 190, then the method 401 proceeds to step 448, where the controller 104 operates one or more switches 170 to prevent power from flowing from the integrated power supply 180 to the external power demand 190. Once step 447 or step 448 is complete, the method 401 can revert to one of the previously-described steps (e.g., step 441). Alternatively, when step 447 or step 448 is complete, then the method 401 can end at the END step.

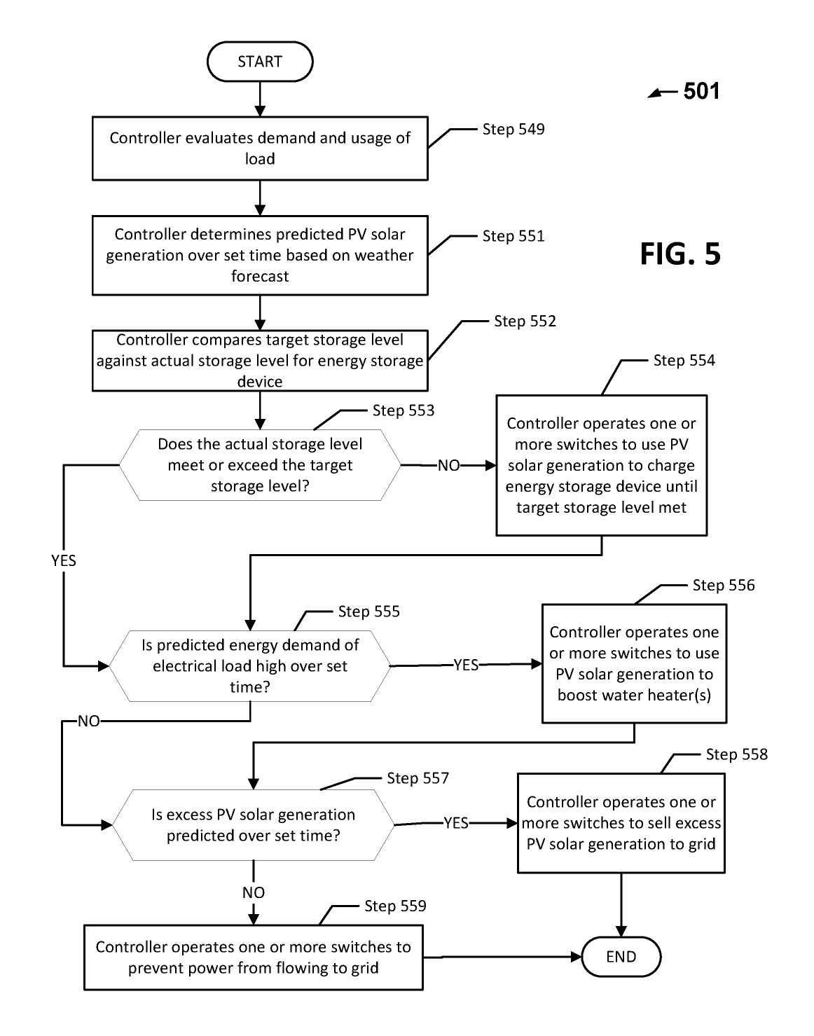

The method 501 of FIG. 5 describes how example embodiments can be used to manage the electrical load 142 and the integrated power supply 180 to determine if power should be sold to the external power demand 190. In the example method 501 of FIG. 5, the alternative generation source 145 includes PV solar generation, and the electrical load 142 includes an electric water heater. The example method 501 of FIG. 5 begins at the START step and proceeds to step 549, where the controller 104 evaluates the demand and usage of the electrical load 142. As with step 444 of the method 401 of FIG. 4, the demand can correspond to an instantaneous peak demand for power, while the usage can correspond to the amount of power (e.g., kWh) consumed by the electrical load 142 over some period of time. The demand and usage of the electrical load 142 can be determined and evaluated using, for example, one or more sensors 160, historical information (e.g., stored data 134), and/or one or more algorithms 133.

In step 551, the controller 104 determines the predicted PV solar generation over a set period of time based on the weather forecast. This is similar to step 443 of FIG. 4, except that in this case, the forecast of alternative generation source 145 is specific to a PV solar generation source. The weather forecast (as well as other relevant information, such as sunset time, ozone levels, amount of dust on the surface of the PV panels, efficiency of each PV panel) can be obtained from one or more sensors 160, the storage repository, and/or an algorithm 133. The period of time can coincide with the period of time for the demand and usage of the electrical load 142.

In step 552, the controller 104 compares the actual storage levels of the energy storage devices 135 with target storage levels of the energy storage devices 135. The actual storage levels of the energy storage devices 135 can be determined, at least in part, using one or more sensors 160 (e.g., energy metering devices). The target storage levels of the energy storage devices 135 correspond to the amount of power stored in the energy storage devices 135 to allow power to be sold from the integrated power supply 180 to the external power demand 190. The target storage levels of the energy storage devices 135 can be determined using, for example, one or more algorithms 133 and stored data 134 (e.g., historical efficiency information for each energy storage device 135).

In step 553, a determination is made as to whether the actual storage levels of the energy storage devices 135 meet or exceed the target storage levels. If the actual storage levels of the energy storage devices 135 meet or exceed the target storage levels, then the method 501 proceeds to step 555. If the actual storage levels of the energy storage devices 135 fall below the target storage levels, then the method 501 proceeds to step 554.

In step 554, the controller 104 operates one or more switches 170 so that the output of the alternative generation source 145 (in this case, the PV solar generation) charges the energy storage devices 135 until the target storage level of the energy storage devices 135 is met. One or more sensors 160 can be used to help determine when the target storage level of the energy storage devices 135 is met. In some cases, additionally or alternatively, the output of one or more other sources of generation (another type of alternative generation source 145, the primary power source 140) in the integrated power supply 180 can be used to charge the energy storage devices 135.

In step 555, a determination is made as to whether the predicted energy demand of the electrical load 142 is high over a period of time. If the predicted energy demand of the electrical load 142 is high over a period of time, then the method 501 proceeds to step 556. If the predicted energy demand of the electrical load 142 is normal or low over a period of time, then the method 501 proceeds to step 557. The predicted energy demand of the electrical load 142 can be determined, at least in part, in a manner similar to step 444 of the method 401 of FIG. 4, described above. Information regarding normal demand of the electrical load can be found, for example, in the storage repository 130.

In step 556, the controller 104 operates one or more switches 170 so that the output of the alternative generation source 145 (in this case, the PV solar generation) provides power to the electrical load 142 (in this case, an electric water heater) to boost the water heater. One or more sensors 160 can be used to help measure the energy consumption of the water heater. In some cases, additionally or alternatively, the output of one or more other sources of generation (another type of alternative generation source 145, the primary power source 140) in the integrated power supply 180 can be used to boost the water heater.

In step 557, a determination is made as to whether excess PV solar generation is predicted over a period of time. If excess PV solar generation is predicted over the period of time, then the method 501 proceeds to step 558. If excess PV solar generation is not predicted over the period of time, then the method 501 proceeds to step 559. The predicted excess PV solar generation can be determined, at least in part, in a manner similar to step 551 described above and comparing this result with the evaluation of the electrical load 142, as described above in step 549.

In step 558, the controller 104 operates one or more switches 170 so that the excess output of the alternative generation source 145 (in this case, the PV solar generation) is delivered to the external power demand 190. In such a case, the amount of excess output of the alternative generation source 145 that is delivered to the external power demand 190 can be measured by an electric power meter (a type of sensor 160).

In step 559, the controller 104 operates one or more switches 170 to prevent power from flowing from the integrated power supply 180 to the external power demand 190. Once step 558 or step 559 is complete, the method 501 can revert to one of the previously-described steps (e.g., step 549). Alternatively, when step 558 or step 559 is complete, then the method 501 can end at the END step.

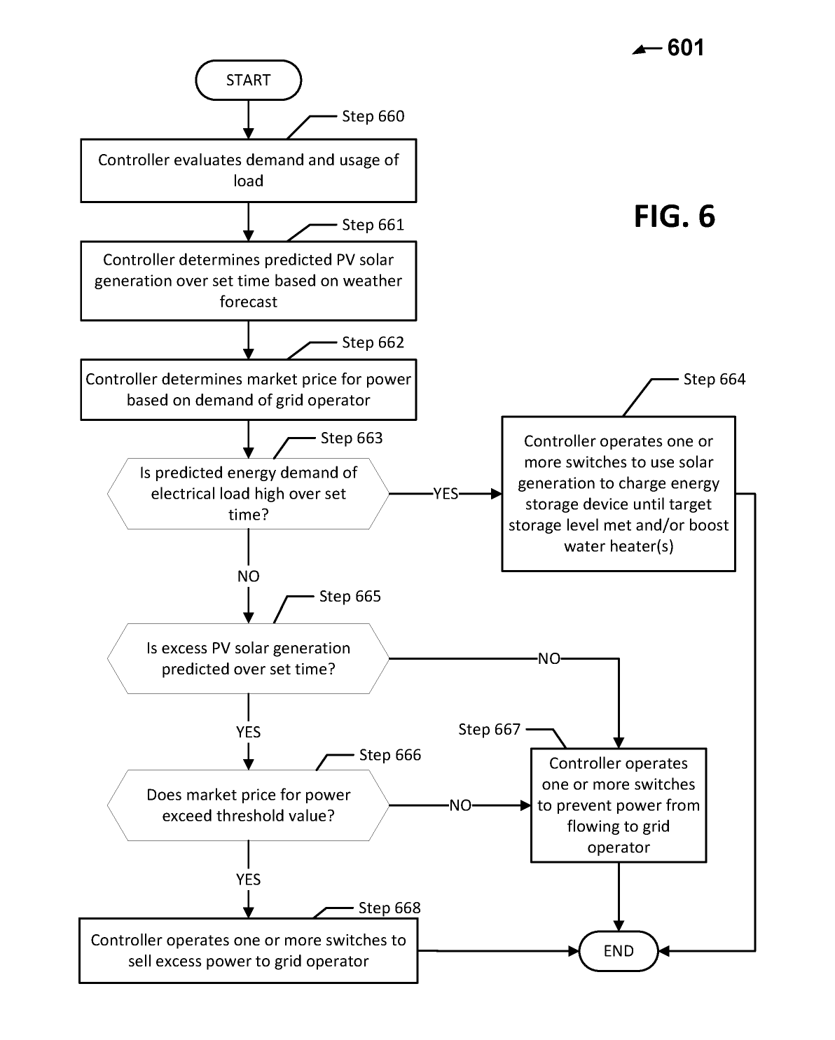

The method 601 of FIG. 6 describes how example embodiments can be used to manage the electrical load 142 and the integrated power supply 180 to determine if power should be sold to the external power demand 190, focusing on market pricing. In the example method 601 of FIG. 6, the alternative generation source 145 includes PV solar generation, the electrical load 142 includes an electric water heater, and the external power demand 190 is a local grid operator. The example method 601 of FIG. 6 begins at the START step and proceeds to step 660, where the controller 104 evaluates the demand and usage of the electrical load 142. As with step 444 of the method 401 of FIG. 4, the demand can correspond to an instantaneous peak demand for power, while the usage can correspond to the amount of power (e.g., kWh) consumed by the electrical load 142 over some period of time. The demand and usage of the electrical load 142 can be determined and evaluated using, for example, one or more sensors 160, historical information (e.g., stored data 134), and/or one or more algorithms 133.

In step 661, the controller 104 determines the predicted PV solar generation over a set period of time based on weather forecast. This is similar to step 551 of FIG. 5. The weather forecast (as well as other relevant information, such as sunset time, ozone levels, amount of dust on the surface of the PV panels, efficiency of each PV panel) can be obtained from one or more sensors 160, the storage repository, and/or an algorithm 133. The period of time can coincide with the period of time for the demand and usage of the electrical load 142.

In step 662, the controller determines the market price for selling excess power based on demand of the grid operator (in this case, the external power demand 190). The excess power can include any one or more of a number of components of power, including but not limited to electricity, reserves, capacity, and RECs. The market price can be provided by one or more of any number of external sources 150, including but not limited to brokers, direct market participants, aggregators, and grid operators. In some cases, the controller 104 can include one or more algorithms 133 that can generate a forward curve of pricing for one or more components of power for some period of time (e.g., balance of the day, next day, weekly, monthly, yearly). The controller 104 can use this information to identify one or more periods of time when there is economic incentive to have excess power from the integrated power supply 145 that can be sold to the external power demand 190.

In step 663, a determination is made as to whether the predicted energy demand of the electrical load 142 (in this case, an electric water heater) is high over one or more periods of time. This determination can be based, at least in part, on the evaluation performed in step 660 discussed above. If the predicted energy demand of the electrical load 142 is determined to be high, then the method 601 proceeds to step 664. If the predicted energy demand of the electrical load 142 is determined not to be high, then the method 601 proceeds to step 665.

In step 664, the controller 104 operates one or more switches 170 so that the output of the alternative generation source 145 (in this case, the PV solar generation) charges the energy storage devices 135 until the target storage level of the energy storage devices 135 is met and/or to boost the water heaters (in this example, the electrical load 142). One or more sensors 160 can be used to help determine when the target storage level of the energy storage devices 135 is met. In some cases, additionally or alternatively, the output of one or more other sources of generation (another type of alternative generation source 145, the primary power source 140) in the integrated power supply 180 can be used to charge the energy storage devices 135 and/or to boost the water heater.

In step 665, a determination is made as to whether excess PV solar generation (an alternative generation source 145) is predicted over the periods of time in question. If excess PV solar generation is predicted over the period of time, then the method 601 proceeds to step 666. If excess PV solar generation is not predicted over the period of time, then the method 601 proceeds to step 667. The predicted excess PV solar generation can be determined, at least in part, in a manner similar to step 661 described above and comparing this result with the evaluation of the electrical load 142, as described above in step 660.

In step 666, a determination is made as to whether the market price for power (including any component thereof) exceeds a threshold value (in this case, a type of stored value 134). The threshold value can be determined by any one or more of a number of factors, including but not limited to age of the PV solar generation equipment, reliability of the PV solar generation equipment, the degree of confidence in forecasts (e.g., weather, load demand, pricing), curtailment measures available for the electrical load 142, and the cost of replacement power if a shortage of power for the electrical load 142 occurs. In certain example embodiments, the controller 104 makes this determination using, for example, one or more algorithms 133 and the results of the evaluations made in one or more of the previously-discussed steps of this method 601. If the market price for power exceeds the threshold value, the method 601 proceeds to step 668. If the market price for power does not exceed the threshold value, the method 601 proceeds to step 667.

In step 667, the controller 104 operates one or more switches 170 to prevent power from flowing from the integrated power supply 180 to the external power demand 190 (the grid operator in this example). In step 668, the controller 104 operates one or switches 170 so that the excess output of the alternative generation source 145 (in this case, the PV solar generation) is delivered to the external power demand 190. In such a case, the amount of excess output of the alternative generation source 145 is delivered to the external power demand 190 can be measured by an electric power meter (a type of sensor 160). Once step 667 or step 668 is complete, the method 601 can revert to one of the previously-described steps (e.g., step 549). Alternatively, when step 667 or step 668 is complete, then the method 601 can end at the END step.

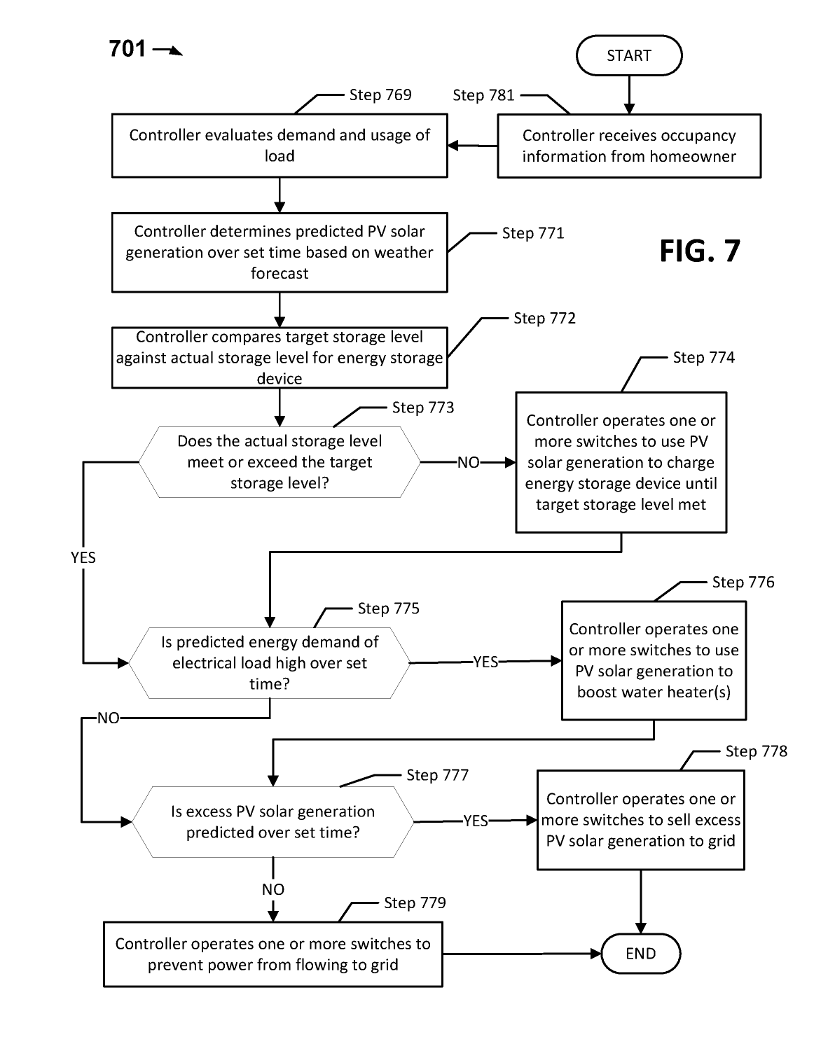

The method 701 of FIG. 7 describes how example embodiments can be used to manage the electrical load 142 and the integrated power supply 180 to determine if power should be sold to the external power demand 190, focusing on input from a user (e.g., a homeowner, a property manager, a manufacturer, a tenant), where the user is a type of external source 150. In the example method 701 of FIG. 7, the alternative generation source 145 includes PV solar generation, and the electrical load 142 includes an electric water heater.

The example method 701 of FIG. 7 begins at the START step and proceeds to step 781, where the controller 104 receives occupancy information from the user. For example, the user can be a homeowner telling the controller 104 (for example, through inputting a setting on the unit or through a calendar schedule) that the occupants (family) will be on vacation next week, and so the house will be vacant during that time. As a result, the user instructs the controller 104 to sell excess power to the external power demand 190 during the vacation. As another example, the next week may be Thanksgiving, and the user notifies the controller 104 that there will be 8 extra occupants staying in the house during that time.

The occupancy information provided by the user can be directly input by the user. Alternatively, the controller 104 can access the occupancy information in some other way. For example, the controller 104 can access the electronic calendar of the user to determine when a vacation or business trip may be taken, corresponding to a period of low demand for the water heater and other electrical load 142. As another example, if the user's electronic calendar shows that the user is picking someone up at the airport, and subsequently dropping the person off at the airport, the controller 104 can determine that there will be increased occupancy during that period of time, and therefore higher demand for the water heater and other electrical load 142.

Steps 769 and 771-779 of the method 701 of FIG. 7 correspond to steps 549 and 551-559, respectively, described above with respect to the method 501 of FIG. 5, except that steps 769 and 771-779 are performed in light of the occupancy information provided, directly and/or indirectly, by the user.

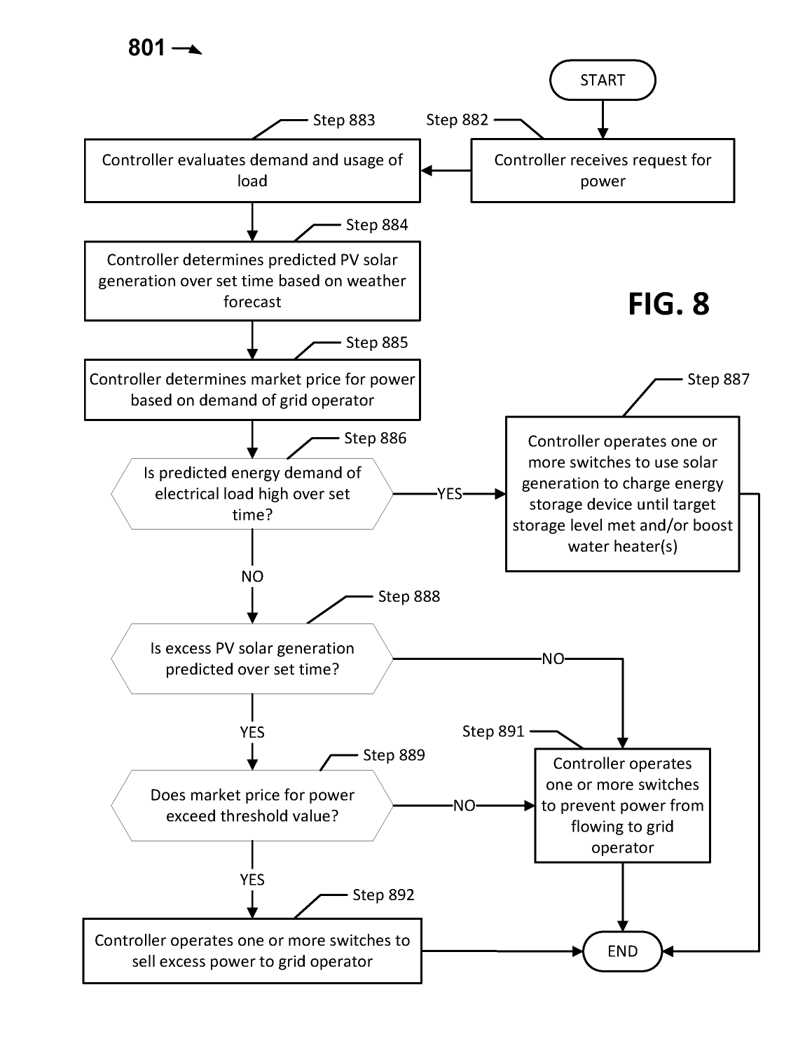

The method 801 of FIG. 8 describes how example embodiments can be used to manage the electrical load 142 and the integrated power supply 180 to determine if power should be sold to the external power demand 190, focusing on an express demand for power from the grid operator. In the example method 801 of FIG. 8, the alternative generation source 145 includes PV solar generation, the electrical load 142 includes an electric water heater, and the external power demand 190 is a local grid operator. The example method 801 of FIG. 8 begins at the START step and proceeds to step 882, where the controller 104 receives a request for power from the external power demand 190 (in this case, the local grid operator). In such a case, the local grid operator acts as both an external source 150 (in making the request for power) and an external power demand 190 (in receiving and buying the power).

Steps 883-889, 891, and 892 of the method 801 of FIG. 8 correspond to steps 660-668, respectively, described above with respect to the method 601 of FIG. 6, except that steps 883-889, 891, and 892 are performed in light of the express demand for power received from the local grid operator. As an alternative instance using example embodiments, if the controller 104 identifies a period of high demand for the electrical load 142, if the PV solar generation is low, and if the local grid operator and/or the controller 104 determines that retail power prices are sufficiently low, then the controller 104 can purchase power from the grid operator to charge the energy storage devices 135.

Example embodiments can integrate one or more power sources (e.g., energy storage devices, one or more alternative generation sources) and distribute that power automatically between an electrical load and an external power demand. Example embodiments can receive input and/or information from any of a number of external sources and process this information to determine how power from each of the various sources within the integrated power supply are to be used. Example embodiments can use a number of switches within the integrated power supply to direct the flow of power and/or prevent power from flowing from a particular power source. In certain example embodiments, the electrical load includes a water heating device (e.g., a traditional electric water heater, a tankless water heater), and the alternative generation source includes PV solar panels. Example embodiments can be used to increase energy efficiency, lower costs, and increase profits.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A system, comprising:
an electrical load that consumes primary power and reserve power;
an alternative generation source coupled to the electrical load, wherein the alternative generation source provides the primary power;
at least one energy storage device coupled to the alternative generation source and the electrical load, wherein the at least one energy storage device provides the reserve power; and
a controller coupled to the alternative generation source and the at least one energy storage device, wherein the controller controls a distribution of the primary power and the reserve power to the electrical load and is configured to provide the primary power and the reserve power to an external power demand,
wherein the controller provides the primary power and the reserve power to the external power demand based, in part, on at least one forecast parameter, wherein the at least one forecast parameter is based on historical data.

2. The system of claim 1, further comprising:
at least one switch having an open position and a closed position, wherein the controller toggles the at least one switch between the closed position and the open position, wherein the distribution of the primary power and the reserve power from the alternative generation source and the at least one energy storage device, respectively, is based on a position of the at least one switch.

3. The system of claim 2, wherein a first switch of the at least one switch is disposed between the alternative generation source and the electrical load and the external power demand, and a second switch of the at least one switch is disposed between the at least one energy storage device and the electrical load and the external power demand.

4. The system of claim 2, wherein the at least one switch further has a neutral position, wherein the controller further toggles the at least one switch between the neutral position, the closed position, and the open position.

5. The system of claim 2, wherein the controller configures the at least one switch so that the alternative generation source provides the primary power to the at least one energy storage device and the electrical load.

6. The system of claim 2, wherein the controller configures the at least one switch so that the alternative generation source provides the primary power to the electrical load and so that the at least one energy storage device provides the reserve power to the external power demand.

7. The system of claim 2, wherein the controller configures the at least one switch so that the alternative generation source provides the primary power to the external power demand and so that the at least one energy storage device provides the reserve power to the electrical load.

8. The system of claim 1, further comprising:
a primary power source coupled to the controller, the at least one energy storage device, and the electrical load, wherein the primary power source provides secondary power, wherein the controller further controls the distribution of the secondary power to the electrical load and the at least one energy storage device.

9. The system of claim 1, further comprising:
at least one sensor coupled to the controller, wherein the at least one sensor measures an amount of power stored in the at least one energy storage device.

10. The system of claim 1, further comprising:
at least one external source coupled to the controller, wherein the at least one external source provides system information, wherein the controller controls the distribution of the primary power and the reserve power to the electrical load and the external power demand based on the system information.

11. The system of claim 10, wherein the system information comprises pricing information.

12. The system of claim 10, wherein the system information comprises a weather forecast and a load forecast.

13. The system of claim 1, wherein the alternative generation source comprises photovoltaic generation.

14. The system of claim 1, wherein the electrical load comprises a water heater.

15. The system of claim 1, wherein the external power demand comprises at least one selected from a group consisting of an electric utility, a grid operator, a retail electric provider, and an energy marketing company.

16. The system of claim 1, wherein the primary power comprises a renewable energy credit.

17. A controller, comprising:
a control engine that controls a distribution of primary power and reserve power to an electrical load and an external power demand, wherein the primary power is provided by an alternative generation source, wherein the reserve power is provided by at least one energy storage device, wherein the electrical load and the external power demand each consume at least one selected from a group consisting of the primary power and the reserve power, wherein the external power demand receives the primary power and the reserve power based, in part, on at least one forecast parameter determined by the control engine, wherein the at least one forecast parameter is based on historical data.

18. The controller of claim 17, further comprising:
a memory that stores a plurality of instructions; and
a hardware processor that executes the plurality of instructions, wherein the controller controls the distribution of the primary power and the reserve power based on the plurality of instructions.

19. A non-transitory computer-readable medium comprising instructions that when executed by a hardware processor perform a method for distributing power in a system from multiple power sources, the method comprising:
forecasting a demand of an electrical load for a future period of time;
forecasting a market price for electricity for the future period of time;
forecasting an amount of reserve power stored in at least one energy storage device for the future period of time;
forecasting an amount of primary power generated by an alternative generation source for the future period of time; and
configuring, at a start of the future period of time, at least one switch based on the demand, the market price, the amount of reserve power stored in the at least one energy storage device, and the amount of primary power generated by the alternative generation source,
wherein configuring the at least one switch distributes the primary power and the reserve power between the electrical load and an external power demand, and
wherein the demand of the electrical load, the market price for electricity, the amount of reserve power, and the amount of primary power is based, at least in part, on historical data.

20. The non-transitory computer-readable medium of claim 19, wherein the amount of primary power generated by the alternative generation source is further forecast using weather forecast information.
